(19) United States
(12) Patent Application Publication
(10) Pub. No.: US 2006/0080330 A1
(43) Pub. Date: Apr. 13, 2006

(54) Image processing apparatus

(75) Inventor: Makoto Sugino, Mishima-shi (JP)

Correspondence Address: SoCAL IP LAW GROUP LLP, 310 N. WESTLAKE BLVD. STE 120, WESTLAKE VILLAGE, CA, 91362, US

(73) Assignees: Kabushiki Kaisha Toshiba, Minato-ku (JP); Toshiba Tec Kabushiki Kaisha, Chiyoda-ku (JP)

(21) Appl. No.: 10/962,009

(22) Filed: Oct. 8, 2004

(51) Int. Cl. G06F 7/00

(52) U.S. Cl. 707/100

(57) ABSTRACT

When a failure is generated in an HDD 15 in a digital multifunction peripheral 1 and various functions provided by a first application 15a stored in the HDD 15 cannot be provided, the digital multifunction peripheral 1 makes sole use of a second application 12c stored in an ROM 12 in advance to provide functions, which can be executed without using the HDD 15.

### BACKGROUND OF THE INVENTION

1. Field of the Invention

The present invention relates to an image processing apparatus such as a digital multifunction peripheral having a mass storage device, e.g., a hard disk drive, and a control method of an image processing apparatus.

2. Description of the Related Art

In recent years, a hard disk drive (HDD) as a mass storage device is provided in an image processing apparatus such as a digital multifunction peripheral. Application programs which provide various kinds of functions of the digital multifunction peripheral are stored in the HDD provided in such a digital multifunction peripheral. Further, image data as a processing target may be stored in the HDD of the above-described digital multifunction peripheral in some cases. In such a structure, when the RDD cannot be used, application programs stored in the HDD cannot be read. Therefore, various kinds of functions of the digital multifunction peripheral provided by the application programs in the HDD cannot be carried out. Furthermore, when the HDD cannot be used, image data as a processing target cannot be held in the HDD. Accordingly, functions which must store image data in the HDD cannot be carried out.

On the contrary, Jpn. Pat. Appln. KOKAI Publication No. 2003-84956 discloses a control method which executes a function which is not affected by a hardware failure when a failure occurs in specific hardware. In Jpn. Pat. Appln. KOKAI Publication No. 2003-84956, however, an application which provides functions when there is no hardware failure is the same as an application which provides functions when a hardware failure occurs. That is, in Jpn. Pat. Appln. KOKAI Publication No. 2003-84956, even if a hardware failure occurs, functions, which can be executed by using a regular application, alone are provided.

In such a control method as disclosed in Jpn. Pat. Appln. KOKAI Publication No. 2003-84956, therefore, when an application itself cannot be activated, the apparatus cannot be operated. Specifically, Jpn. Pat. Appln. KOKAI Publication No. 2003-84956 has a problem that, when a failure is generated in a storage device which stores an application, functions which are not affected by the failure of the storage device (functions which can be executed without using this storage device) cannot be executed either.

### BRIEF SUMMARY OF THE INVENTION

It is an object of the present invention to provide an image processing apparatus which can provide specific functions even if a failure is generated in a storage device, and a control method of an image processing apparatus.

According to the present invention, there is provided an image processing apparatus comprising: a first storage device in which a first application program to provide various functions is previously stored and which stores image data which is a processing target in various functions provided by the first application program; a second storage device in which a second application program which provides functions, which can be executed without using the first storage device, alone is previously stored; and a control section which causes functions provided by the first application program stored in the first storage device to be executable when the first storage device can be used, and causes functions, which are provided by the second application program stored in the second storage device, alone to be executable when the first storage device cannot be used.

According to the present invention, there is provided a control method of an image processing apparatus, comprising: previously storing a first application program which provides various functions in a first storage device; previously storing a second application program which provides functions, which can be executed without using the first storage device, alone in a second storage device; causing functions provided by the first application program stored in the first storage device to be executable when the first storage device can be used; and causing functions, which are provided by the second application program stored in the second storage device, alone to be executable when the first storage device cannot be used.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a block diagram schematically showing a structure of a digital multifunction peripheral as an image processing apparatus according to a first embodiment of the present invention;

FIG. 2 is a flowchart illustrating activation processing for the digital multifunction peripheral as the first embodiment;

FIG. 3 is a view showing a relationship between an ROM, an RAM and an HDD in the activation processing as the first embodiment;

FIG. 4 is a view schematically showing a structural example of an image processing system including a digital multifunction peripheral according to a second embodiment;

FIG. 5 is a flowchart illustrating an activation processing for the digital multifunction peripheral as the second embodiment;

FIG. 6 is a view schematically showing a digital multifunction peripheral to which an external device such as a removal medium is connected according to a third embodiment; and

FIG. 7 is a flowchart illustrating activation processing for the digital multifunction peripheral as the third embodiment.

### DETAILED DESCRIPTION OF THE INVENTION

The best embodiments which carry out the present invention will now be described with reference to the accompanying drawings.

First, a description will be given as to a structure of a digital multifunction peripheral 1 as an image processing apparatus according to first, second and third embodiments of the present invention.

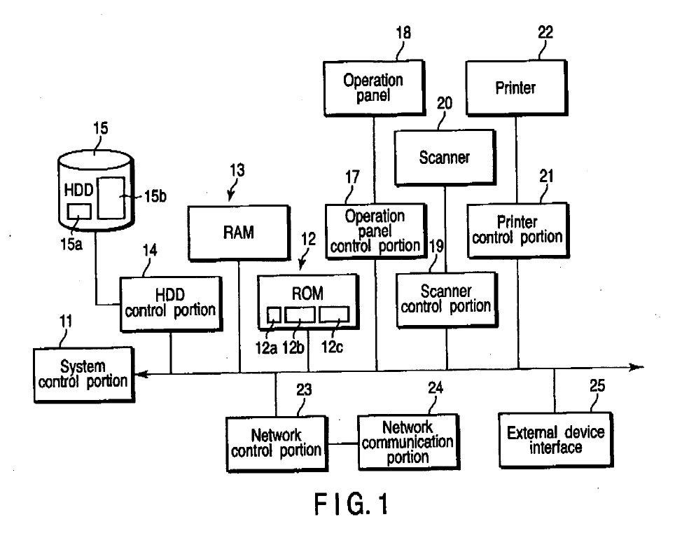

FIG. 1 is a block diagram schematically showing a structure of the digital multifunction peripheral 1.

As shown in FIG. 1, the digital multifunction peripheral 1 has a system control section 11, an ROM (Read Only Memory) 12, an RAM (Random Access Memory) 13, a hard disk drive (HDD) control section 14, a hard disk drive (HDD) 15, an operation panel control section 17, an operation panel 18, a scanner control section 19, a scanner 20, a printer control section 21, a printer 22, a network control section 23, a network communication section 24 and others.

The system control section 11 controls the entire digital multifunction peripheral 1. The ROM 12 comprises a non-volatile memory. The ROM 12 stores a control program which controls the digital multifunction peripheral 1, control data or the like. For example, the ROM 12 stores a boot loader 12a, an OS (operating system) 12b, a second application 12c and the like. The boot loader 12a is a control program which activates the digital multifunction peripheral 1. The OS 12b is a control program as a basic which activates the digital multifunction peripheral 1. The second application 12c is an application program which executes some functions of the digital multifunction peripheral 1. This second application 12c will be described later in detail.

The RAM 13 comprises, e.g., a volatile general-purpose memory. The RAM 13 stores programs or data for operations. For example, the OS and a first application 15a, a second application 12c or the like is loaded in the RAM 13.

The HDD control section 14 is an interface for the HDD 15, and controls access to the HDD 15. The HDD 15 is a mass storage device. For example, the first application 15a is stored in the HDD 15 in advance. The HDD 15 has a larger capacity than that of the ROM 12 or the like. Moreover, the first application 15a is a program which provides various kinds of functions realized by the digital multifunction peripheral 1, and has a large program size (data quantity). In this first embodiment, therefore, it is determined that the first application 15a which provides various kinds of functions realized by the digital multifunction peripheral 1 is stored in the HDD 15. Additionally, the HDD 15 has a storage area 15b which stores image data as an image processing target such as image data scanned by the scanner 20 and image data subjected to print processing by the printer 22.

The operation panel control section 17 controls the operation panel 18. The operation panel 18 is a user interface having a display section and an operation section. In the operation panel 18, an operation guidance for a user or a state of operation settings of the digital multifunction peripheral is displayed by using the display section, and an operation instruction from a user is input by the operation section. For example, the operation panel 18 comprises a display device having a built-in touch panel and a hard key such as a ten-key keypad.

The scanner control section 19 controls the scanner 20. The scanner 20 optically reads an image on an original document, and converts this image into image data.

The printer control section 21 controls the printer 22. The printer 22 forms an image on an image forming medium. The printer 22 performs printing on the image forming medium based on, e.g., image data read by the scanner 20 or image data supplied from the outside.

The network control section 23 controls data communication in a network 5 performed by the network communication section 24. The network communication section 24 is a network interface which performs data communication with each device in the network 5.

The external device interface 25 is an interface for a removal medium which is directly connected with the digital multifunction peripheral 1. The external device interface 25 is an interface such as USB, SCSI, IEEE1394. As the external device which is a removal medium connected through the external device interface 25, there are, e.g., a USB memory, a hard disk drive, a CD drive, a DVD drive and others.

The first embodiment will now be described.

Here, activation processing as the first embodiment of the digital multifunction peripheral 1 having the above-described structure will be explained.

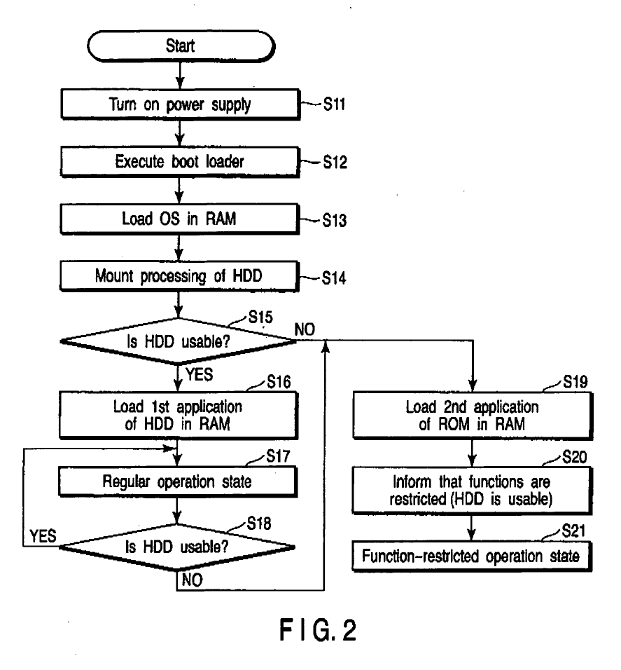

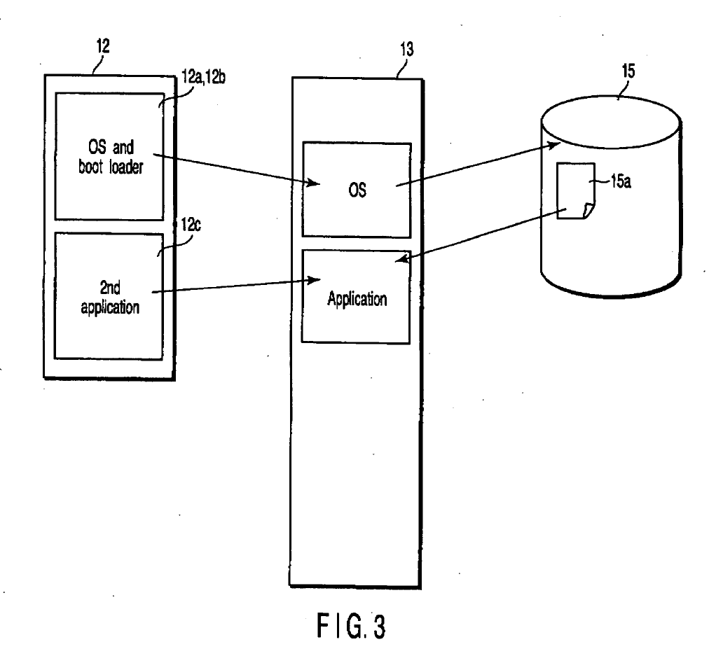

FIG. 2 is a flowchart illustrating activation processing for the digital multifunction peripheral 1 as the first embodiment. Further, FIG. 3 is a view showing a relationship between the ROM 12, the RAM 13 and the HDD 15 in the activation processing as the first embodiment.

First, it is assumed that a user turns on a main power supply of the digital multifunction peripheral 1. Then, a power is supplied to each section in the digital multifunction peripheral 1 from a non-illustrated power supply section (step S11). When the power is supplied, the system control section 11 activates the boot loader 12a stored in the ROM 12 (step S12). The boot loader 12a is a program which checks operations of respective sections in the digital multifunction peripheral. It is to be noted that, if the boot loader 12a is not required, the step S12 is eliminated.

When the boot loader 12a is executed, the system control section 11 loads the OS 12b stored in the ROM 12 to the RAM 13 as shown in FIG. 3 (step S13). The OS 12b is an operating system which executes the first application 15a stored in the HDD 15 or the second application 12c stored in the ROM 12. In other words, the first application 15a or the second application 12c operates on the OS 12b loaded in the RAM 13.

When the OS 12b is loaded in the RAM 13, the system control section 11 performs mount processing with respect to the HDD 15 as shown in FIG. 3 (step S14). This mount processing is processing which identifies the HDD 15 and data in the HDD 15. In this mount processing, for example, a file system (format) or the like in the HDD 15 is checked.

In such mount processing, the system control section 11 judges whether the HDD 15 can be used (step S15). If it is determined that the HDD 15 can be used based on this judgment (step S15, YES), the system control section 11 reads the first application 15a from the HDD 15 and loads it in the RAM 13 as shown in FIG. 3 (step S16).

The first application 15a stored in the HDD 15 comprises at least one program which realizes various kinds of functions provided by the digital multifunction peripheral 1. For example, the first application 15a stored in the HDD 15 provides all functions executed by the digital multifunction peripheral 1. When the first application 15a is loaded in the RAM 13, the digital multifunction peripheral 1 enters a state in which various functions provided by the first application 15a are enabled (i.e., a regular operation state) (step S17).

Furthermore, in the regular operation state, the system control section 11 monitors whether the HDD 15 can be used (step S58). As a result, when a failure is generated in the HDD 15 and the HDD 15 cannot be used in the regular operation state (step S18, NO), the system control section 11 advances to a later-described step S19 in order to perform later-described processing.

Incidentally, when a failure of the HDD 15 is generated in a process in which the first application 15a is loaded in the RAM 13 (step S18, NO), the system control section 11 likewise proceeds to the later-described step S19 in order to perform the is later-described processing.

Moreover, if it is determined that the HDD 15 cannot be used based on the above-described judgment (step S51, NO), the system control section 11 reads the second application 12c from the ROM 12 and loads it in the RAM 13 as shown in FIG. 3 (step S19).

The second application 12c stored in the ROM 12 comprises a program which carries out functions, which can be executed without using the HDD 15, only for certain functions provided by the digital multifunction peripheral 1. That is, the second application 12c is a program which restricts or decreases functions the digital multifunction peripheral 1 fundamentally has, and provides the restricted or decreased functions. It is to be noted that a concrete example of functions provided by the second application 12c will be described later.

When the second application 12c stored in the ROM 12 is loaded in the RAM 13, the system control section 11 displays a message informing that the digital multi-function peripheral can be used in a state that the functions are restricted or decreased (i.e., the HDD is not used) by using the display section of the operation panel 18. As a result, a user can be informed of a state of the digital multifunction peripheral. Additionally, at this time, the system control section 11 may inform maintenance service personnel of the digital multifunction peripheral of the fact that a failure is generated in the HDD 15 through the network or the like.

When the second application 12c is loaded in the RAM 13, the digital multifunction peripheral 1 enters a state in which only functions provided by the second application 12c can be used (i.e., an operation state with functions being restricted) (step S21).

As described above, when a failure is generated in the HDD 15 and functions using the RDD 15 provided by the first application 15a in the HDD 15 cannot be provided, the second application 12c which is stored in the ROM 12 and only provides functions which can be executed without using the HDD 15 is loaded in the RAM 13.

As a result, even if a failure is generated in the HDD 15, the digital multifunction peripheral 1 can be operated in a state that the functions are restricted until the HDD is restored.

The second application 12c will now be described.

As described above, it is premised that the second application 12c provides functions which can be executed without using the HDD 15 as a mass storage device. Therefore, the second application 12c provides functions in a state that functions provided by the first application 15a stored in the HDD 15 are restricted or decreased. Examples of functions provided by this second application are as follows.

First, the second application 12c provides a function which can be executed without storing image data in the HDD 15 in copy processing and print processing.

For example, in cases where a plurality of parts of image data comprising a plurality of pages are printed, image data corresponding to a plurality of pages is temporarily stored in the HDD and printing a plurality of parts of the image data comprising the plurality of pages is realized in a regular operation state (functions provided by the first application). On the contrary, when the HDD 15 becomes unserviceable, image data cannot be stored in the HDD 15. Therefore, the second application 12c does not provide a function for copying a plurality of pairs of a plurality of pages or a function for printing a plurality of pages.

Further, if image data can be held in a storage device (e.g., the RAM 13) other than the HDD 15, the second application 12c may provide a copy function or a print function for a plurality of parts of image data comprising up to pages which can be stored in the storage device other than the HDD 15. In this case, the second application 12c enables the storage device which stores the image data to operate as the storage device other than the HDD. That is, different from the first application 15a, the second application 12c is a control routine which holds image data in a storage device such as the RAM, other than the NDD.

For the same reason, the second application 12c does not provide a sort function which is realized by temporarily holding image data in the HDD either. For example, in a magazine sort function, a first page is printed on a front surface of a first paper sheet and a last page is printed on a rear surface so that a printing result becomes a book. That is, in the magazine sort function, printing cannot be started unless image data for all pages are acquired (held).

Therefore, the second application 12c does not provide the sort function in the control routine which holds image data in the HDD 15. Therefore, the second application does not provide the sort function, or do provide the sort function up to pages which can be held in a storage device such as the RAM 13 other than the NDD 15.

Furthermore, if the HDD 15 cannot be used, scanned image data cannot be stored in the HDD 15 in the digital multifunction peripheral 1. Accordingly, the second application 12c does not provide a function which files scanned image data in the HDD 15 (an image filing function).

However, the second application 12c provides as a scanner function a function which stores (transfers) scanned image data in a PC or an MFP which can be accessed by the network communication section 24 through the network, or a function which stores (transfers) scanned image data in an external device connected through the external device interface 25.

Incidentally, if the digital multifunction peripheral is connected to the network by the network communication section 24, the second application 12c may provide the above-described functions by storing image data in a storage section in an external device on the network in place of the HDD 15. Moreover, if an external device having a storage section is connected with the digital multifunction peripheral through the external device interface 25, the second application may provide the above-described functions by storing image data in the storage section of the external device instead of the HDD 15.

The second embodiment will now be described.

The second embodiment is realized by an image processing system in which a digital multifunction peripheral having such a hardware structure as shown in FIG. 1 is connected to another apparatus through a network.

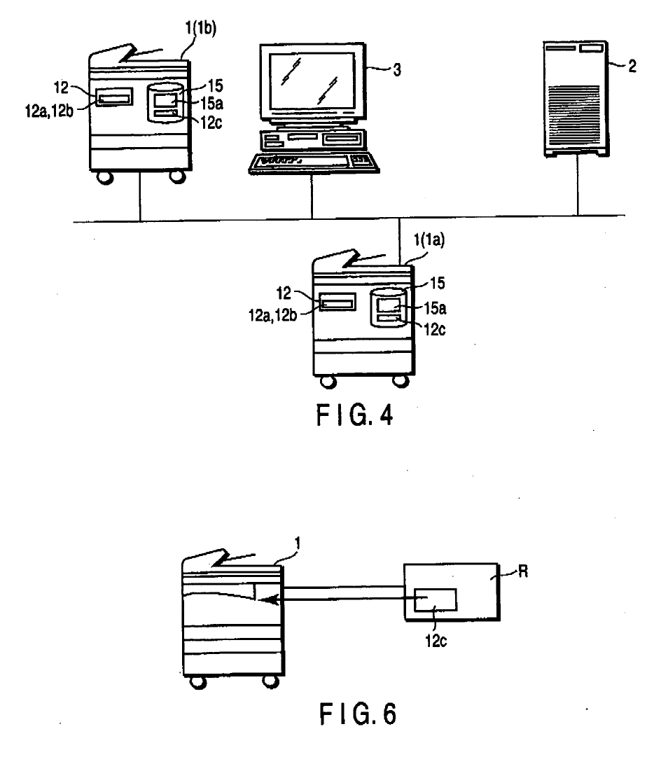

FIG. 4 is a view schematically showing a structural example of an image processing system including digital multifunction peripherals 1.

In the image processing system depicted in FIG. 4, a plurality of digital multifunction peripherals 1 (1a, 1b), a file server 2, a client PC 3 and others are connected through a network 5 such as a local area network.

The digital multifunction peripherals 1a and 1b have such a hardware structure as shown in FIG. 1, and they can communicate with each other by a network communication section 24 through the network 5. Additionally, in the second embodiment, it is determined that the second application 12c is stored in an HDD 15 in place of a ROM 12 in the digital multifunction peripherals 1a and 1b.

The file server 2 is a server computer which can communicate with the digital multifunction peripherals 1a and 1b through the network 5. The file server 2 comprises, e.g., a mass storage device. The client PC 3 is a computer (PC) which can communicate with the digital multifunction peripherals 1a and 1b through the network 5. The client PC 3 is a PC used by a user. It is to be noted that the second application 12c may be stored in the file server 2 or the client PC 3.

A description will now be given as to activation processing as the second embodiment for the digital multifunction peripherals 1 in such an image processing system.

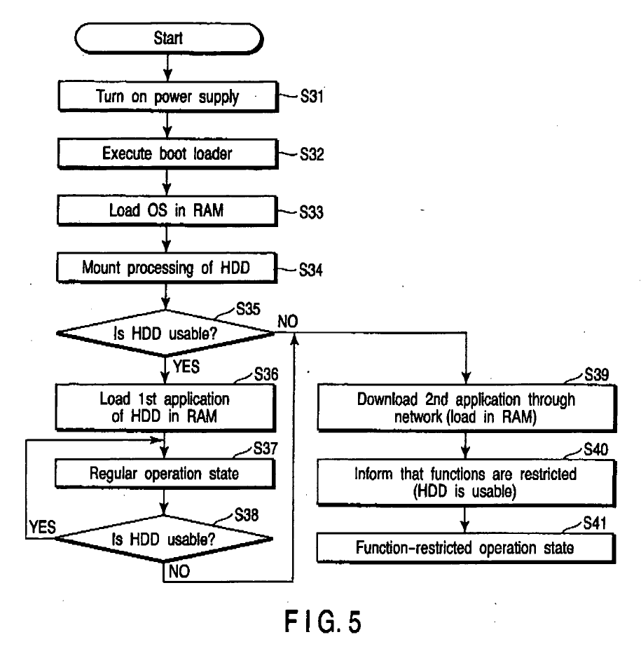

FIG. 5 is a flowchart illustrating the activation processing for the digital multifunction peripheral 1a as the second embodiment.

First, if there is no failure in the HDD 15, i.e., if the HDD 15 can be used, a first application 15a in the HDD 15 is loaded in an RAM 13 and the digital multifunction peripheral 1a enters a regular operation state by the same operations as the steps S11 to S18 (steps S31 to S33).

Further, if it is determined that the HDD 15 cannot be used when a power supply is turned on (step S35, NO) or if a failure is generated in the HDD 15 in the regular operation state (step S38, NO), a system control section 11 in the digital multifunction peripheral 1a downloads the second application 12c from the other digital multifunction peripheral 1b connected with the counterpart by the network communication section 24 through the network 5.

As a method of downloading the second application 12c by the digital multifunction peripheral 1a through the network, there is, e.g., the following method.

First, the digital multifunction peripheral 1a searches for the digital multifunction peripheral 1b having the same structure as the digital multifunction peripheral 1a in the network. Based on a search result, the digital multifunction peripheral 1a accesses the digital multifunction peripheral 1b having the same structure, and downloads the second application 12c from this digital multifunction peripheral 1b.

Furthermore, the digital multifunction peripheral 1b from which the second application 12c is downloaded is set in the digital multifunction peripheral 1a in advance. As a result, the digital multifunction peripheral 1a accesses the previously set digital multifunction peripheral 1b, and downloads the second application 12c from the digital multifunction peripheral 1b.

Moreover, the second application 12c is previously stored in the file server 2 or the client PC 3 which can communicate with the digital multifunction peripheral 1a through the network 5. In addition to this, the file server 2 or the client PC 3 storing the second application 12c therein is set in the digital multifunction peripheral 1a. As a result, the digital multifunction peripheral 1a accesses the previously set file server 2 or client PC 3, and downloads the second application from the file server 2 or the client PC 3.

When the second application 12c is downloaded through the network by the above-described processing, the system control section 11 loads the downloaded second application 12c in the RAM 13 (step S39).

When the second application 12c downloaded through the network is loaded in the RAM 13, the system control section 11 displays a message informing that the digital multifunction peripheral can be used with functions being restricted or decreased (i.e., the HDD is not used) in a display section of the operation panel 18 (step S40), and causes the digital multifunction peripheral 1a to enter a state in which functions provided by the second application 12c only can be used (i.e., an operation state in which functions are restricted) (step S41).

It is to be noted that, in the second embodiment, the second application 12c may provide functions which can only be executed without using the HDD 15 of the digital multifunction peripheral 1a, or may provide functions by using a storage section in an external device which can communicate through the network in place of the HDD 15 of the digital multifunction peripheral 1a.

As described above, when a failure is generated in the HDD 15 and functions using the HDD 15 which are provided from the first application 15a in the HDD 15 cannot be provided, the second application 12c which provides through the network functions which can only be executed without using the HDD 15 is loaded in the RAM 13.

As a result, the digital multifunction peripheral 1 can be operated in a state in which functions are restricted when a failure is generated in the HDD 15, without storing the second application in the ROM 12 (without the second application occupying a storage area of the ROM 12).

The third embodiment will now be described.

The third embodiment is realized in a state that an external device is connected to a digital multifunction peripheral having such a hardware structure as shown in FIG. 1. Further, in the third embodiment, it is determined that the second application 12c is not stored in an ROM 12 of the digital multifunction peripheral 1.

FIG. 6 is a view schematically showing a digital multifunction peripheral having an external device R such as a removal medium connected thereto. In the digital multifunction peripheral 1 in a state shown in FIG. 6, data stored in a storage section of the external device can be acquired. Furthermore, as the external device R, there are, e.g., a USB memory, a hard disk drive, a CD drive, a DVD drive and others.

A description will now be given as to activation processing for the digital multifunction peripheral 1 with the external device R connected thereto as the third embodiment.

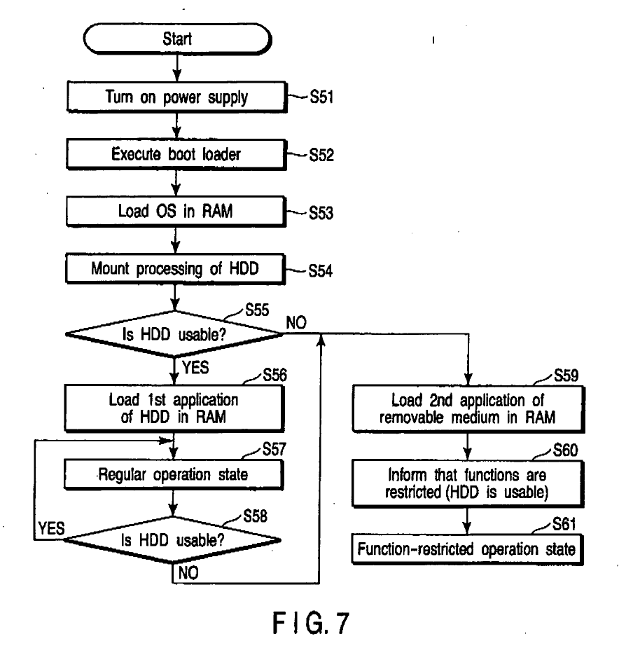

FIG. 7 is a flowchart illustrating activation processing for the digital multifunction peripheral 1 as the third embodiment.

First, if there is no failure in the HDD 15, i.e., if the HDD 15 can be used, a first application 15a in the HDD 15 is loaded in a RAM 13 by the same operations as the steps S11 to S18, and the digital multifunction peripheral 1 enters a regular operation state (steps S51 to S58).

Moreover, if it is determined that the HDD 15 cannot be used when a power supply is turned on (step S55, NO), or if a failure is generated in the HDD in the regular operation (step S58, NO), a system control section 11 of the digital multifunction peripheral 1 reads the second application 12c from the external device R connected through the external device interface 25 (step S58), and loads it in the RAM 13 (step S59).

Incidentally, if the external device R is not connected, or if the-second application 12c cannot be read from the external device A, the system control section 11 may stop the operation of the digital multifunction peripheral 1. In this case, a message informing that the digital multifunction peripheral 1 cannot operate due to a failure in the HDD and absence of the external device is displayed in the operation panel 18. On the contrary, when a user connects the external device having the second application 12c stored therein and again turns on the power supply, the digital multifunction peripheral 1 can operate by using the second application 12c.

When the second application 12c read from the external device R by the above-described processing is loaded in the RAM 13, the system control section 11 displays in a display section of the operation panel 18 a message informing that the digital multifunction peripheral can be used with functions being restricted or decreased (i.e., the HDD is not used) (step S60) like the steps S20 and S21, and causes the digital multifunction peripheral 1 to enter a state in which functions provided by the second application 12c alone can be used (i.e., an operation state with functions being restricted) (step S61).

It is to be noted that, in the third embodiment, the second application 12c may provide functions executable without using the HDD 15 of the digital multifunction peripheral 1 alone, or may provide functions by using the storage section of the external device R in place of the HDD 15 of the digital multifunction peripheral 1.

As described above, when a failure is generated in the HDD 15 and functions using the HDD 15 provided by the first application 15a in the HUD 15 cannot be provided, the second application 12c which provides functions executable without using the HDD 15 alone is loaded in the RAM 13 from the external device R connected with the digital multifunction peripheral 1.

As a result, when a failure is generated in the HDD 15, the digital multifunction peripheral 1 can be operated with functions being restricted without storing the second application in the ROM 12 (without the second application occupying a storage area of the ROM).

It is to be noted that the first, second and third embodiments presume that the application which realizes services or functions provided by the digital multifunction peripheral 1 (the first application) is stored in the HDD as a mass storage device. That is because services or functions provided by the digital multifunction peripheral 1 diversify in many ways and hence a program size (data quantity) of the first application which realizes all functions (or many functions) is increased.

It is realistic to store the first application having such a large data quantity in a mass storage device such as an HDD whose unit price per capacity is relatively low in terms of cost. For example, if the above-described first application is stored in a ROM whose unit price per storage area is higher than that of the HDD, a cost of the digital multifunction peripheral becomes very high.

On the contrary, in the first embodiment, an application, which is used when a failure occurs in the HDD, alone is stored in the ROM. Additionally, in the second embodiment, the second application is stored in the HDD of an external device such as another digital multifunction peripheral which is accessible through a network. Further, in the third embodiment, the second application is stored in an external device which can be directly connected with the digital multifunction peripheral.

As a result, in the first, second and third embodiments, even if the HDD having the first application stored therein cannot be used, the digital multifunction peripheral can be operated with functions of the digital multifunction peripheral being restricted or decreased.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general invention concept as defined by the appended claims and their equivalents.

What is claimed is:

1. An image processing apparatus comprising:
a first storage device in which a first application program to provide various functions is previously stored and which stores image data which is a processing target in various functions provided by the first application program;
a second storage device in which a second application program which provides functions, which can be executed without using the first storage device, alone is previously stored; and
a control section which causes functions provided by the first application program stored in the first storage device to be executable when the first storage device can be used, and causes functions, which are provided by the second application program stored in the second storage device, alone to be executable when the first storage device cannot be used.

2. The image processing apparatus according to claim 1, wherein the first storage device is a hard disk drive.

3. The image processing apparatus according to claim 1, wherein the second storage device is a read only memory.

4. The image processing apparatus according to claim 1, wherein the control section judges whether the first storage device can be used when the image processing apparatus is activated.

5. The image processing apparatus according to claim 1, further comprising an informing section which informs that functions of the image processing apparatus are restricted when functions, which are provided by the second application program stored in the second storage device, alone are executable.

6. The image processing apparatus according to claim 1, further comprising a third storage device,
wherein the second application provides functions which can be executed by using the third storage device in place of the first storage device.

7. The image processing apparatus according to claim 6, wherein the third storage device is a random access memory.

8. The image processing apparatus according to claim 1, further comprising an interface which connects a removal medium,
wherein the second application program provides functions which can be executed by using the removal medium connected by the interface in place of the first storage device.

9. The image processing apparatus according to claim 1, further comprising an interface which connects a removal medium,
wherein the second storage device is the removal medium connected by the interface.

10. The image processing apparatus according to claim 1, further comprising a network interface which is connected with a network,
wherein the second storage device is a storage device in an external device connected by the network interface through the network.

11. A control method of an image processing apparatus, comprising:
previously storing a first application program which provides various functions in a first storage device;
previously storing a second application program which provides functions, which can be executed without using the first storage device, alone in a second storage device;
causing functions provided by the first application program stored in the first storage device to be executable when the first storage device can be used; and
causing functions, which are provided by the second application program stored in the second storage device, alone to be executable when the first storage device cannot be used.

12. The control method of an image processing apparatus according to claim 11, wherein the first storage device is a hard disk drive.

13. The control method of an image processing apparatus according to claim 11, wherein the second storage device is a read only memory.

14. The control method of an image processing apparatus according to claim 11, further comprising judging whether the first storage device can be used when the image processing apparatus is activated.

15. The control method of an image processing apparatus according to claim 11, further comprising informing that functions of the image processing apparatus are restricted when functions, which are provided by the second application program stored in the second storage device, alone can be executed.

16. The control method of an image processing apparatus according to claim 11, wherein the image processing apparatus further comprises a third storage device, and
the second application program provides functions which can be executed by using the third storage device in place of the first storage device.

17. The control method of an image processing apparatus according to claim 16, wherein the third storage device is a random access memory.

18. The control method of an image processing apparatus according to claim 11, wherein the second application program provides functions which can be executed by using a removal medium connected to the image processing apparatus in place of the first storage device.

19. The control method of an image processing apparatus according to claim 1, wherein the second storage device which stores the second application program is the removal medium connected to the image processing apparatus.

20. The control method of an image processing apparatus according to claim 1, wherein the second storage device which stores the second application program is a storage device in an external device which can communicate with the image processing apparatus through a network.
